(19) United States
(12) Patent Application Publication
(10) Pub. No.: US 2023/0386433 A1
(43) Pub. Date: Nov. 30, 2023

(54) Self-Contained Collapsible Cajón

(71) Applicant: Brian N Caringer, Belleville, IL (US)

(72) Inventor: Brian N Caringer, Belleville, IL (US)

(21) Appl. No.: 18/362,765

(22) Filed: Jul. 31, 2023

Related U.S. Application Data
(60) Provisional application No. 63/365,599, filed on May 31, 2022.

(51) Int. Cl. G10D 13/02

(52) U.S. Cl. CPC G10D 13/02

(57) ABSTRACT

A self-contained collapsible cajón. The cajón collapses for transportation and storage, and the cajón expands for musical play. The cajón does not require removal of any parts or the use of any tools to collapse or expand. The sides of the cajón fold inward and the back face moves inward to reduce the volume of the cajón. The top and bottom plates rotate inward and are secured to the back face.

### FIELD OF THE INVENTION

The present invention relates generally to musical instruments. The present invention relates more specifically to box drums.

### BACKGROUND OF THE INVENTION

A cajón, also known as a box drum, is a box-shaped percussion instrument, played by slapping the front or rear faces with the hands, fingers, or implements, such as brushes, mallets, or sticks. A cajón is typically made with a fixed frame, occupying a substantial volume.

It is an objective of the present invention to provide a cajón that collapses to a smaller volume during storage and transportation. It is an objective of the present invention to provide a collapsible cajón that maintains musical fidelity. It is a further objective of the present invention to provide a collapsible cajón that does not require the use of tools to collapse or expand. It is an objective of the present invention to provide a cajón without risk of inadvertent collapse during use.

### SUMMARY OF THE INVENTION

A self-contained collapsible cajón. The cajón collapses for transportation and storage, and the cajón expands for musical play. The cajón does not require removal of any parts or the use of any tools to collapse or expand. The sides of the cajón fold inward and the back face moves inward to reduce the volume of the cajón. The top and bottom plates rotate inward and are secured to the back face.

### BRIEF DESCRIPTION OF THE DRAWINGS

FIG. 1 is a perspective view of Embodiment 1 of the present invention in an expanded configuration.

FIG. 2 is a perspective view of Embodiment 1 of the present invention in an expanded configuration.

FIG. 3 is a front elevation view of Embodiment 1 of the present invention in an expanded configuration in which a sectional plane is taken and shown in FIG. 10.

FIG. 4 is a rear elevation view of Embodiment 1 of the present invention in an expanded configuration in which a sectional plane is taken and shown in FIG. 11.

FIG. 5 is a top plan view of Embodiment 1 of the present invention in an expanded configuration.

FIG. 6 is a bottom plan view of Embodiment 1 of the present invention in an expanded configuration.

FIG. 7 is a left-side elevation view of Embodiment 1 of the present invention in an expanded configuration.

FIG. 8 is a right-side elevation view of Embodiment 1 of the present invention in an expanded configuration in which a sectional plane is taken and shown in FIG. 9.

FIG. 9 is a rear sectional view of Embodiment 1 of the present invention in an expanded configuration taken along plane 9-9 in FIG. 8.

FIG. 10 is a right-side sectional view of Embodiment 1 of the present invention in an expanded configuration taken along plane 10-10 in FIG. 3.

FIG. 11 is a top section view of Embodiment 1 of the present invention in an expanded configuration take along plane 11-11 in FIG. 4.

FIG. 12 is a perspective view of Embodiment 1 of the present invention in a collapsed configuration.

FIG. 13 is a front elevation view of Embodiment 1 of the present invention in a collapsed configuration.

FIG. 14 is a rear elevation view of Embodiment 1 of the present invention in a collapsed configuration.

FIG. 15 is a top plan view of Embodiment 1 of the present invention in a collapsed configuration.

FIG. 16 is a bottom plan view of Embodiment 1 of the present invention in a collapsed configuration.

FIG. 17 is a left-side elevation view of Embodiment 1 of the present invention in a collapsed configuration.

FIG. 18 is a right-side elevation view of Embodiment 1 of the present invention in a collapsed configuration.

FIG. 19A is a perspective view of Embodiment 1 of the present invention in an expanded configuration.

FIG. 19B is a perspective view of Embodiment 1 of the present invention in a first intermediate configuration.

FIG. 19C is a perspective view of Embodiment 1 of the present invention in a second intermediate configuration.

FIG. 19D is a perspective view of Embodiment 1 of the present invention in a collapsed configuration.

### DETAILED DESCRIPTION OF THE INVENTION

All illustrations of the drawings are for the purpose of describing selected versions of the present invention and are not intended to limit the scope of the present invention.

The present invention represents a self-contained collapsible cajón, also known as a box drum. The cajón collapses by folding into itself to occupy a smaller volume in order to make transportation easier. No parts of the cajón must be removed, and no tools are required to collapse or expand the cajón. The vertical orientation of the side frames, side panels, and back face support the weight of the user without risk of collapsing unexpectedly.

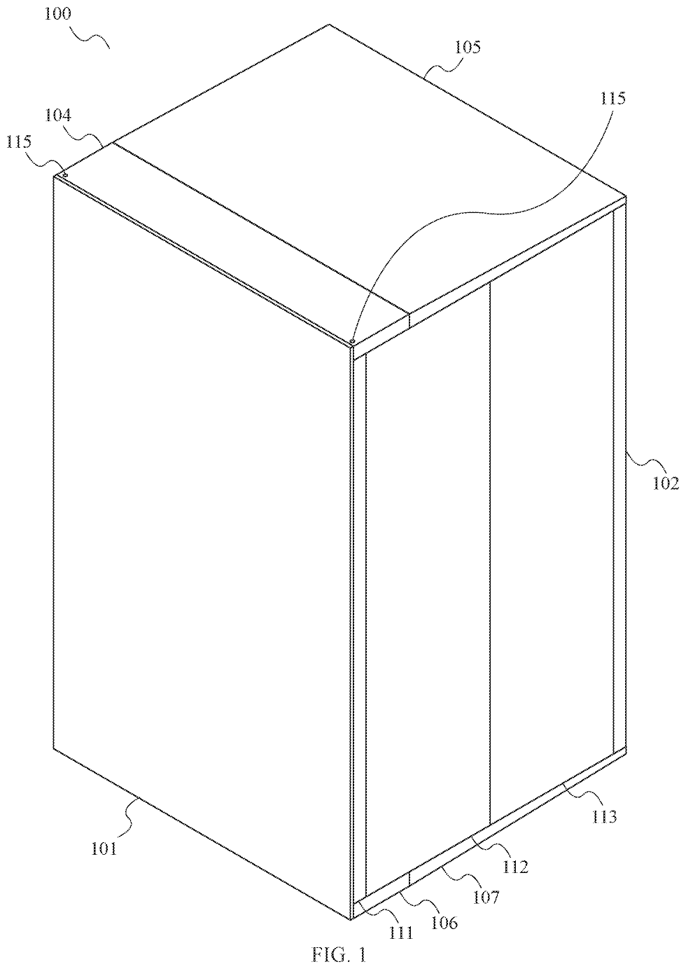

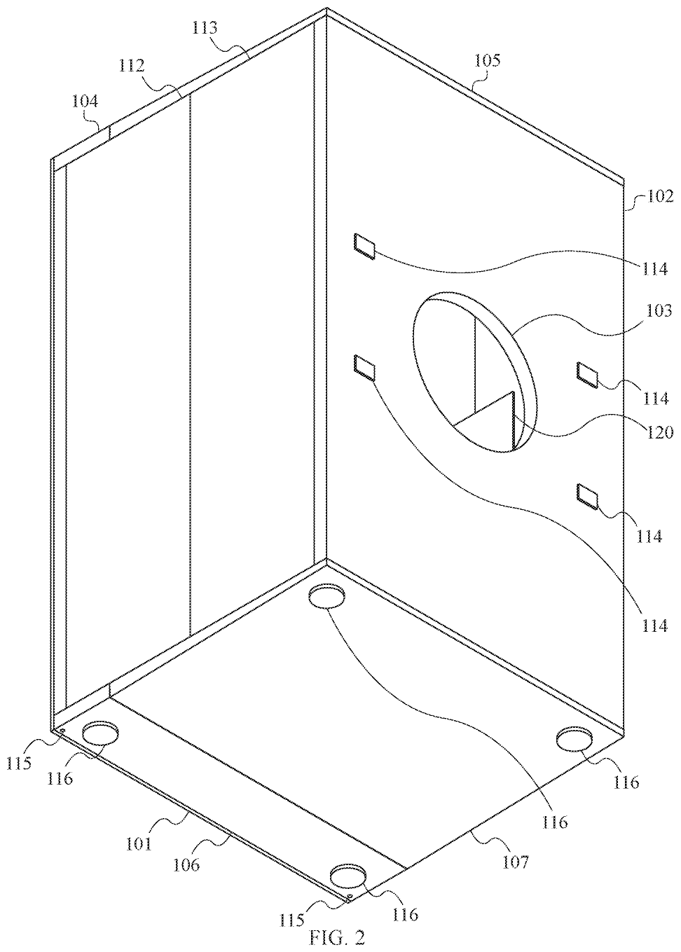

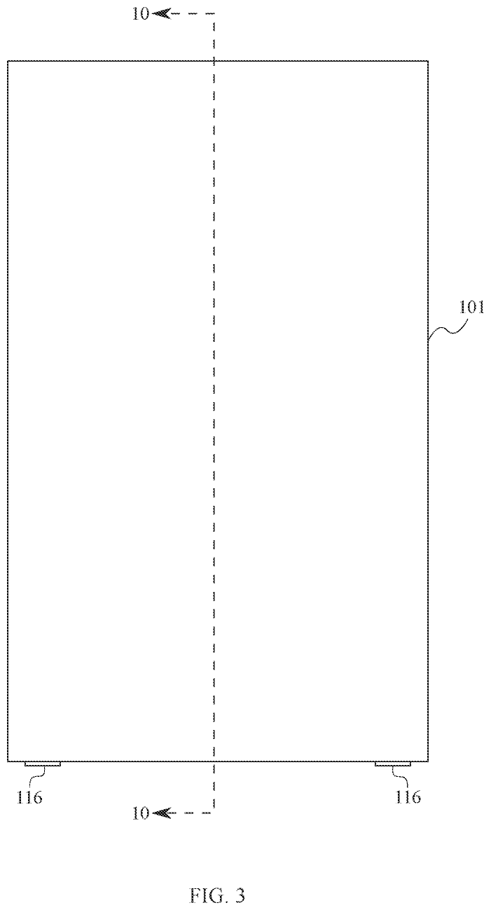

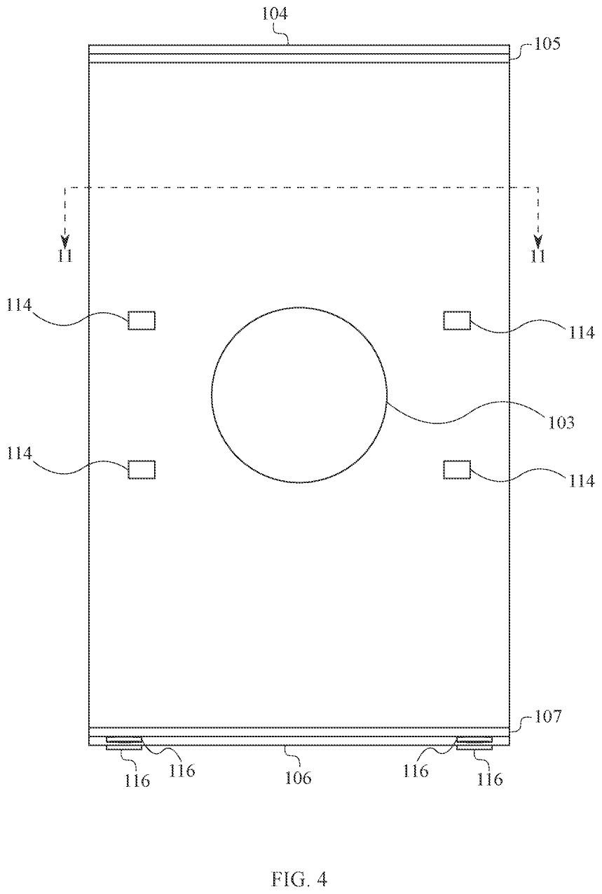

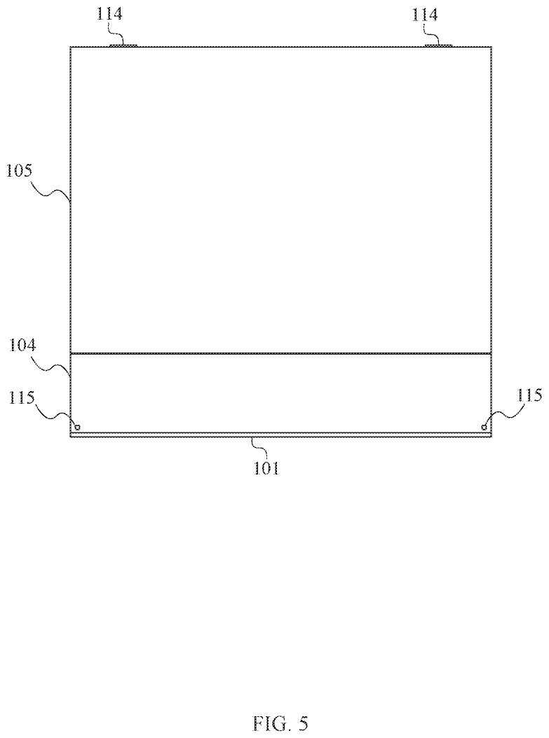

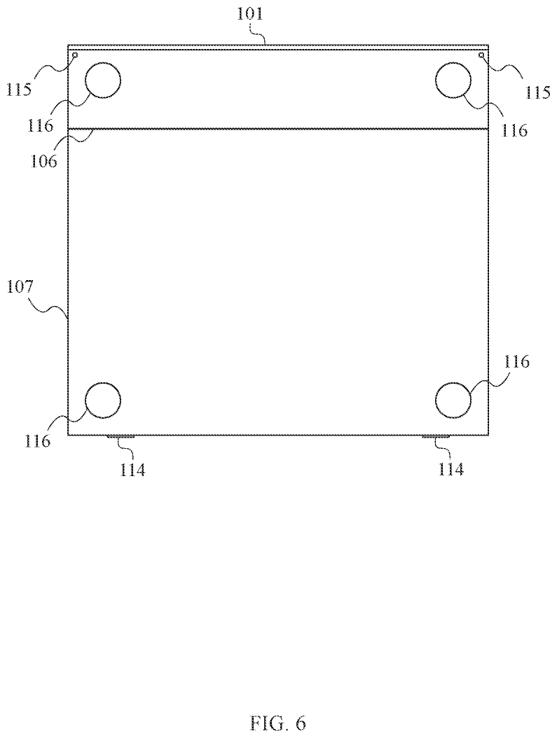

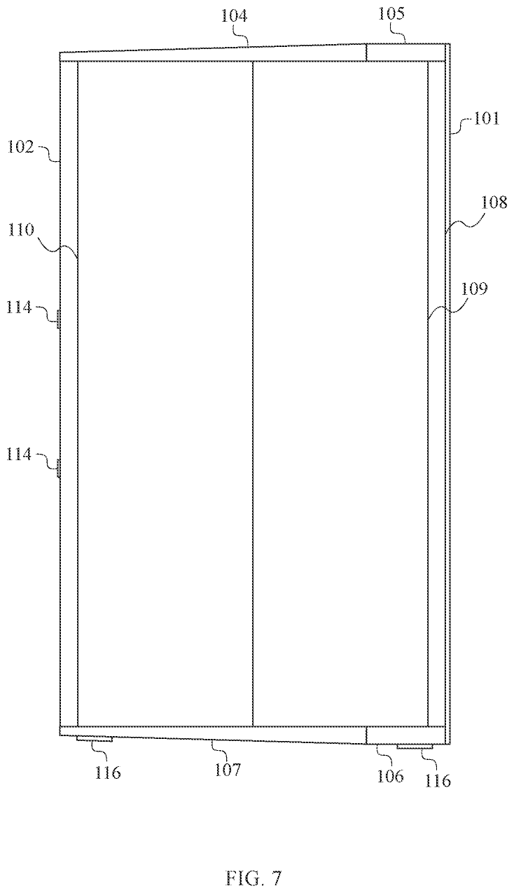

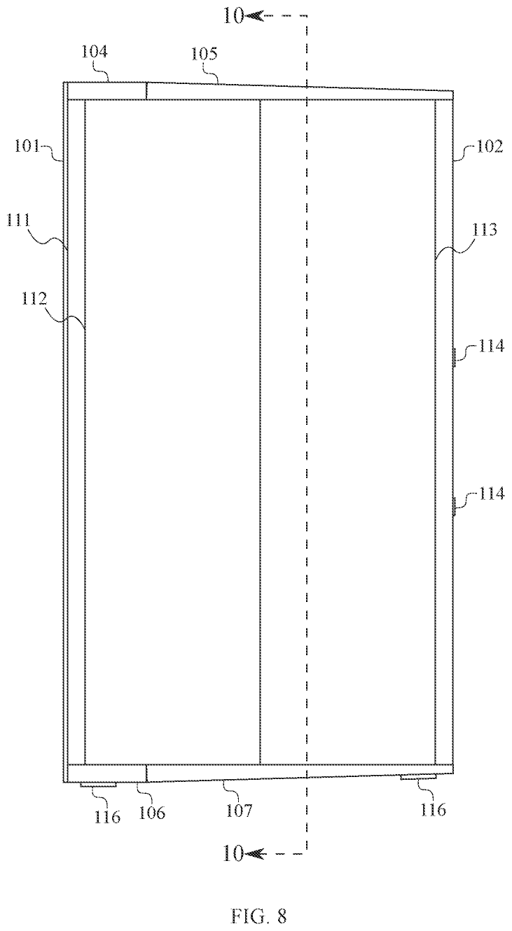

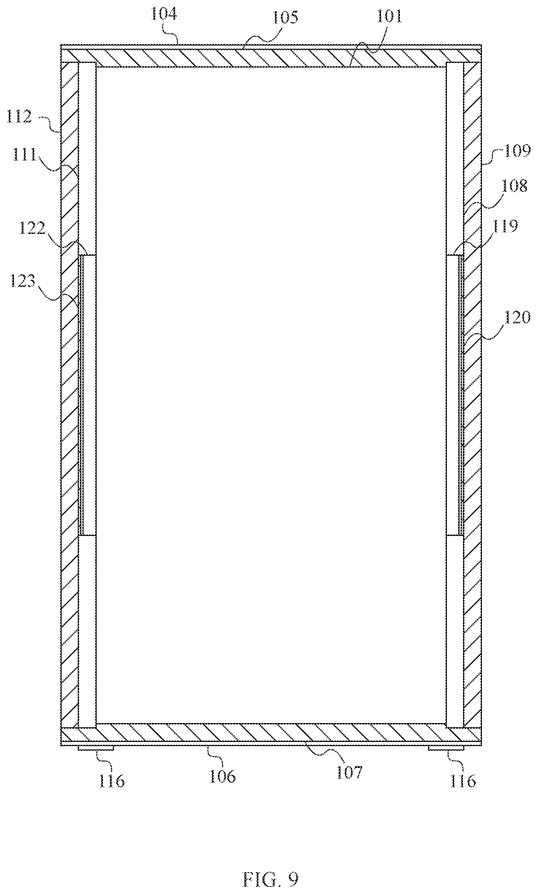

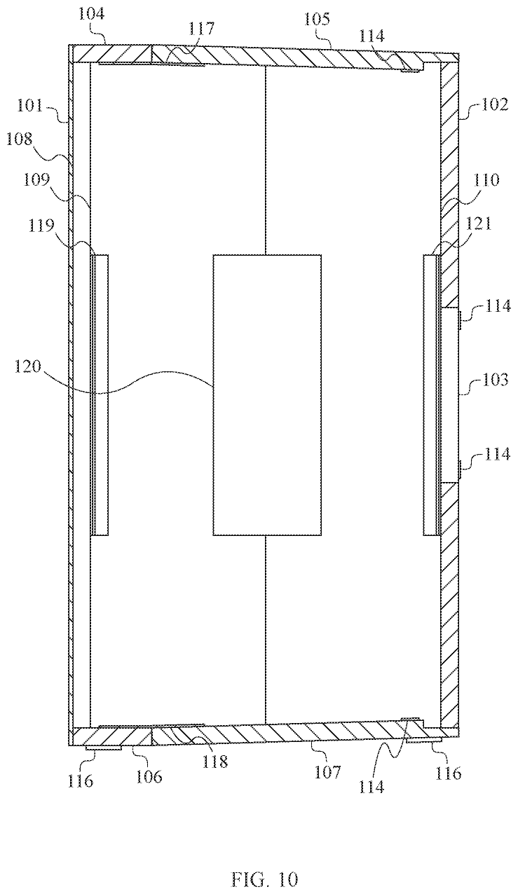

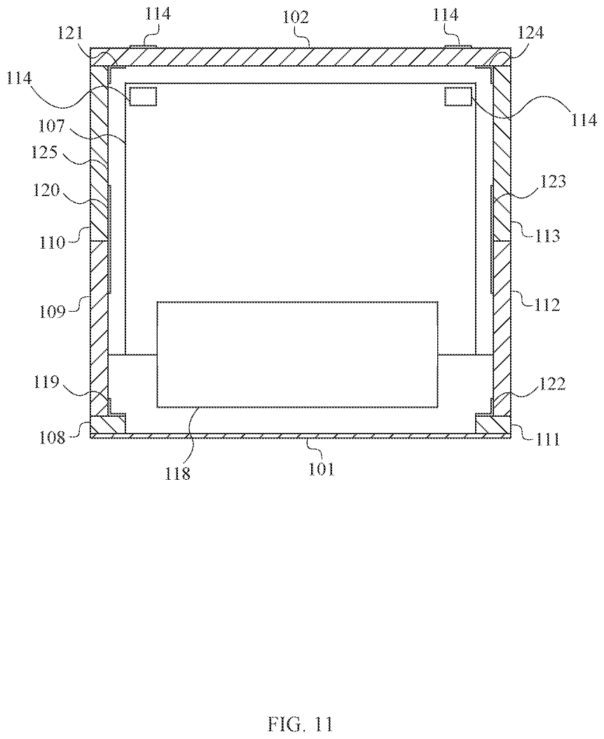

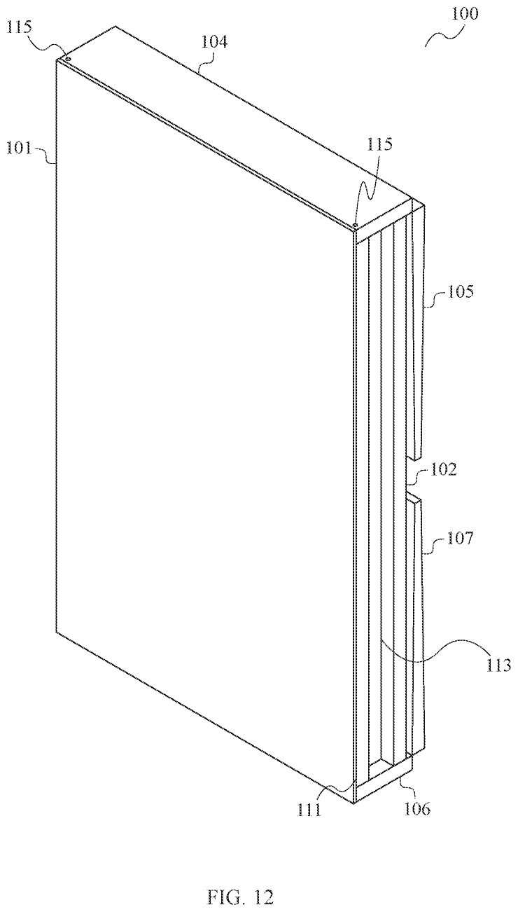

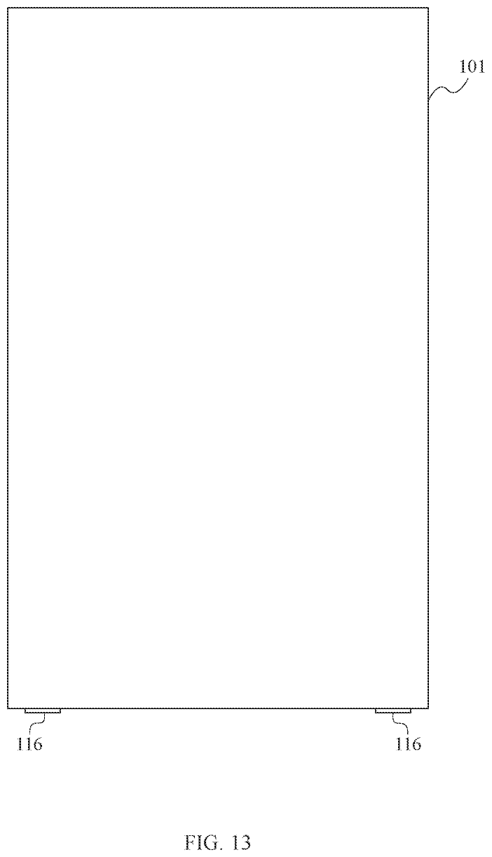

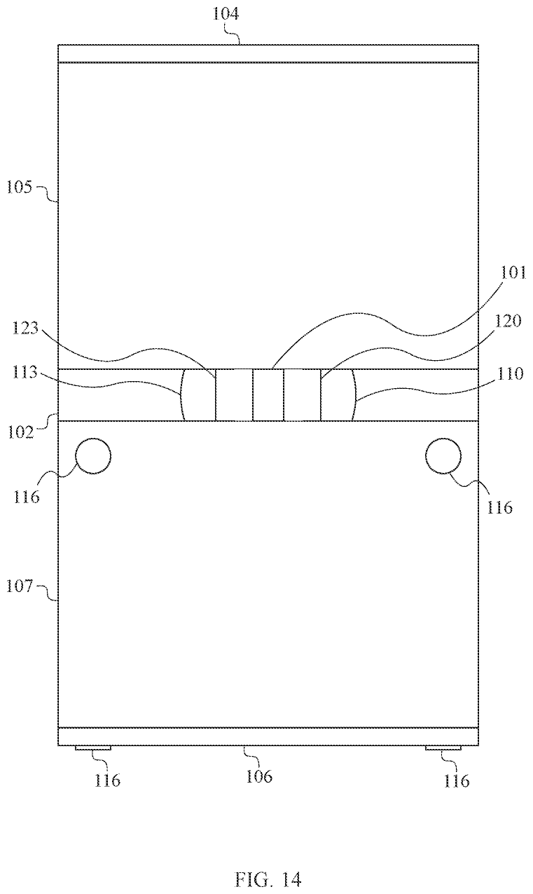

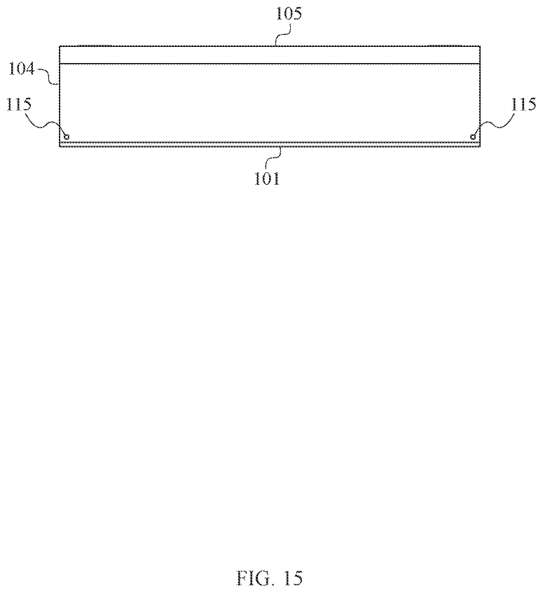

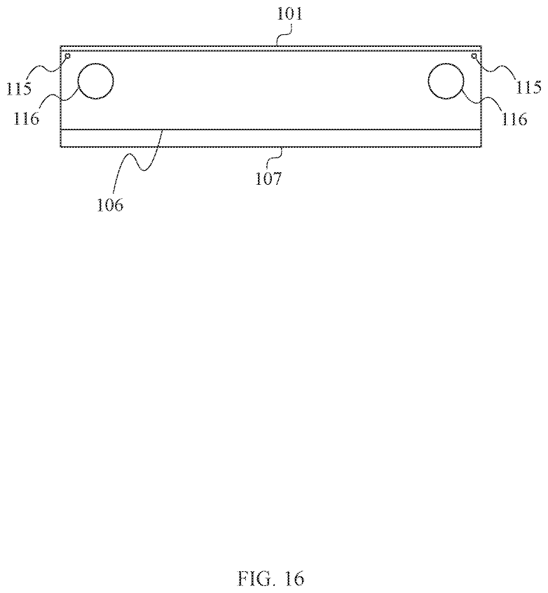

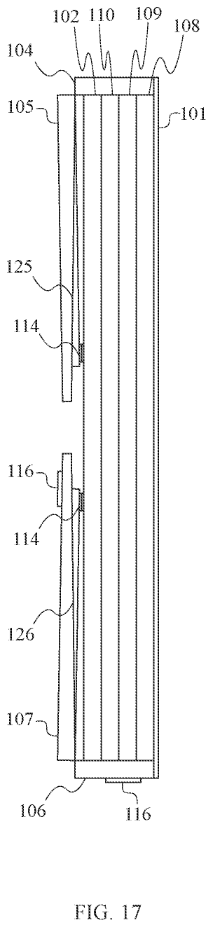

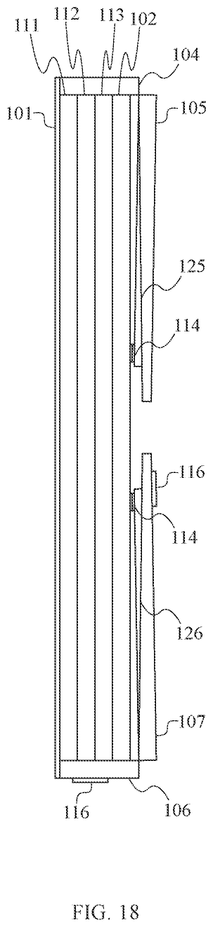

Referring to FIGS. 1-18, Embodiment 1 of the present invention comprises a cajón 100. The front face 101 is located on the front of cajón 100. The front face 101 is the primary striking surface to produce sound, or play music, with the cajón 100. In alternate embodiments, a snare is attached to the surface of the front face 101 facing the interior of the cajón 100. The front face 101 is connected to a frame formed by the top frame 104, the bottom frame 106, the left frame 108, and the right frame 111. In Embodiment 1, the front face 101 is connected to the frame with a series of screws around the perimeter of the front face 101. In Embodiment 2, the front face 101 is connected to the frame with adhesive. In alternate embodiments, different means of connected the front face 101 to the frame may be used. The back face 102 is located on the opposite side of the cajón 100 from the front face 101. The back face 102 includes a sound hole 103, which allows sound waves to exit the interior of the cajón 100. In Embodiment 1, the sound hole 103 is centered on the back face 102. In alternate embodiments, the sound hole 103 may be located off-center on the back face 102.

The top frame 104, the bottom frame 106, the left frame 108, and the right frame 111 are connected to form a rectangular frame. The top frame 104 is connected to a top surface of the left frame 108 and a top surface of the right frame 111. The bottom frame 106 is connected to a lower surface of the left frame 108 and to a lower surface of the right frame 111.

In Embodiment 1, reinforcing dowels 115 reinforce the frame during construction. One reinforcing dowel 115 is inserted through the top frame 104 into the left frame 108. A second reinforcing dowel 115 is inserted through the top frame 104 into the right frame 111. A third reinforcing dowel 115 is inserted through the bottom frame 106 into the left frame 108. A fourth reinforcing dowel 115 is inserted through the bottom frame 106 into the right frame 111. In alternate embodiments, the reinforcing dowels 115 are omitted. In alternate embodiments, more than four reinforcing dowels 115 are used.

The moving parts of cajón 100 are joined by a series of cloth hinges 117-124. Each hinge is comprised of a sturdy, flexible fabric, which adheres to the two joined parts with adhesive. In alternate embodiments, other types of hinges may be used.

The top plate 105 is connected to the top frame 104 by a top hinge 117. The top hinge 117 is adhered to the top frame 104 and to the top plate 105 with adhesive. The top hinge 117 allows the top plate 105 to be rotated upward and downward. Similarly, the bottom plate 107 is connected to the bottom frame 106 by a bottom hinge 118. The bottom hinge 118 is adhered to the bottom frame 104 and to the bottom plate 107 with adhesive. The bottom hinge 118 allows the top plate to rotate upward and downward.

The right front side panel 112 is connected to the right frame 111 with a right front hinge 122. The right front hinge 122 is adhered to the right front side panel 112 and to the right frame 111 with adhesive. The right front hinge 122 allows the right front side panel 112 to rotate towards the interior volume of the cajón 100. The right front side panel 112 is connected to the right back side panel 113 with a right middle hinge 123. The right middle hinge 123 is adhered to right front side panel 112 and to the right back side panel 113 with adhesive. The right middle hinge 123 allows the right front side panel 112 and the right back side panel 113 to rotate such that the exterior surfaces of the side panels approach each other. The right back side panel 113 is connected to the back face 102 with a right back hinge 124. The right back hinge 124 is adhered to the right back side panel 113 and to the back face 102 with adhesive. The right back hinge 124 allows the right back side panel 113 to rotate towards the interior of the cajón 100.

Similarly, the left front side panel 109 is connected to the left frame 108 with a left front hinge 119. The left front hinge 119 is adhered to the left front side panel 109 and to the left frame 108 with adhesive. The left front hinge 119 allows the left front side panel 109 to rotate towards the interior volume of the cajón 100. The left front side panel 109 is connected to the left back side panel 110 with a left middle hinge 120. The left middle hinge 120 is adhered to the left front side panel 109 and to the left back side panel 110 with adhesive. The left middle hinge 120 allows the left front side panel 109 and the left back side panel 110 to rotate such that the exterior surfaces of the side panels approach each other. The left back side panel 110 is connected to the back face 102 with a left back hinge 121. The left back hinge 121 is adhered to the left back side panel 110 and to the back face 102 with adhesive. The left back hinge 121 allows the left back side panel 110 to rotate towards the interior of the cajón 100.

Four feet 116 are located on the bottom surface of the cajón 100. Two feet 116 are connected to the bottom frame 106 adjacent to the exterior corners of the cajón 100. Two additional feet 116 are connected to the bottom plate 107 adjacent to the exterior corners of the cajón 100. The feet 116 provide addition grip to hold the cajón 100 in place during use. In alternate embodiments, different numbers and locations of feet 116 may be used.

Fasteners 114 are connected to the back face 102, the top plate 105, and the bottom plate 107. Two pairs of fasteners 114 couple the top plate 105 to the back face 102. Similarly, two pairs of fasteners 114 couple the bottom plate 107 to the back face 102. The fasteners 114 couple the top plate 105 and the bottom plate 107 to the back face 102 to secure the top plate 105 and the bottom plate 107 in the collapsed configuration and prevent movement of the top plate 105 and the bottom plate 107 during transportation. In Embodiment 1, the fasteners comprise hook and loop material. In Embodiment 3, the fasteners comprise magnets. In alternate embodiments, other fasteners may be used.

The top plate 105 includes a tapered rabbet cut 125. The bottom plate 107 includes a tapered rabbet cut 126. The tapered rabbet cuts 125 and 126 improve the musical quality of the sound produced by the cajón 100. The tapered rabbet cuts 125 and 126 help prevent air from escaping around the top plate 105 and the bottom plate 107. In addition, the tapered rabbet cuts 125 and 126 help secure the location of the back face 102 and side panels 109, 110, 112, and 113 in the expanded configuration.

In embodiment 1, the front face 101, the back face 102, the top frame 104, the top plate 105, the bottom frame 106, the bottom plate 107, the left frame 108, the left front side panel 109, the left back side panel 110, the right frame 111, the front right side panel 112, and the right back side panel 113 are comprised of wood. The wood preferably has qualities suitable for the construction of musical instruments. In alternate embodiments, other materials suitable for the construction of musical instruments may be used.

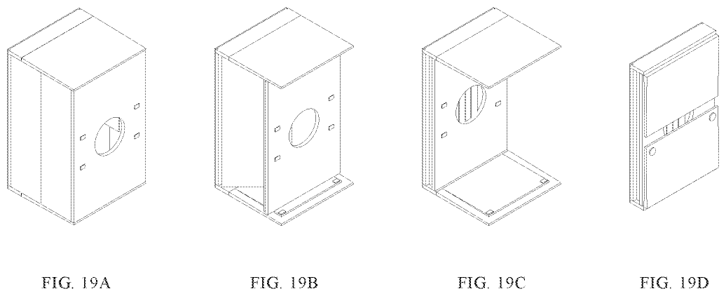

Referring to FIG. 19A, the cajón 100 is in a fully expanded configuration. Referring to FIG. 19B, the cajón 100 is collapsed by first pushing the left front side panel 109, the left back side panel 110, the right front side panel 112, and the right back side panel 113 towards the interior of the cajón 100. The left front side panel 109 and the left back side panel 110 will rotate around the left middle hinge 120. Similarly, the right front side panel 112 and the right back side panel 113 will rotate around the right middle hinge. The top plate 105 must be lifted slightly and the bottom plate 107 must be lowered slightly to allow the side panels 109, 110, 112, and 113 and the back face 102 to exit the tapered rabbet cuts 125 and 126. As the side panels 109, 110, 112, and 113 are pushed inward, the back face 102 will be pulled towards the interior of the cajón 100 by the left back hinge 121 and the right back hinge 124. Referring to FIG. 19C, the back face 102 is pushed towards the front face 101. Pushing the back face 102 causes the interior surface of the left front side panel 109 to contact the left frame 108 and similarly causes the interior surface of the right front side panel 112 to contact the right frame 111. In addition, pushing the back face 102 causes the exterior surface of the left back side panel 110 to contact the exterior surface of the left front side panel 109 and causes the interior surface of the back face 102 to contact the interior surface of the left back side panel 110. Similarly, pushing the back face 102 causes the exterior surface of the right back side panel 113 to contact the exterior surface of the right front side panel 112 and causes the interior surface of the back face 102 to contact the interior surface of the right back side panel 113. Referring to FIG. 19D, the top plate 105 is rotated downward and secured by coupling the fasteners 114 on the top plate 105 to the fasteners 114 on the back face 102. The bottom plate 107 is rotated upward and secured by coupling the fasteners 114 on the bottom plate 107 to the fasteners on the back face 102. With the top plate 105 and the bottom plate 107 secured, the cajón 100 has achieved the collapsed configuration.

To expand the cajón 100, the steps to collapse are reversed. Referring to FIG. 19D, the cajón 100 is in a collapsed configuration. Referring to FIG. 19C, the fasteners 114 are uncoupled. The bottom plate 107 is lowered, and the top plate 105 is raised. Referring to FIG. 19B, the back face 102 is pulled away from the front face 101. The sound hole 103 may be gripped to pull the back face 102. Pulling the back face 102 causes the side panels 109, 110, 112, and 113 to rotate and move outwardly from the center of the cajón 100. Referring to FIG. 19A, the side panels 109, 110, 112, and 113 have fully rotated and are seated in the tapered rabbet cut 126 of the bottom plate 107 and the tapered rabbet cut 125 of the top plate 105. Similarly, the top edge of the back face 102 is seated in the tapered rabbet cut 125 of the top plate 104, and the bottom edge of the back face 102 is seated in the tapered rabbet cut 126 of the bottom plate 107. With the back face 102 and side panels 109, 110, 112, and 113 seated, the cajón 100 has achieved the expanded configuration, and the cajón is ready to be played.

According to Embodiment 1, the components are sized according to the following proportions to provide optimal sound quality. Where the overall height of the cajón 100 is represented by H, the overall width of the cajón 100 is represented by W, and the overall depth of the cajón 100 (not including the thickness of the front face) is represented by D. T represents the thickness of the boards used to construct the frames, side panels, plates, and back face.
Height: 2(D−2T)
Width: D+2T
Depth: 2(H−2T)
Front face: H×W×0.25T
Back face: (H−2T)×W×T
Radius of sound hole: 0.25W−T
Top and bottom frames: W×4.5T×T
Top and bottom plates: W×(D−4.5T)×T
Tapered rabbet width: 2T
Left and right frames: (H−2T)×2T×T
Side panels: (H−2T)×(D−2T)×T

For an example with a height of 20 inches and board thickness of 0.5 inch, the width is 12 inches, and the depth is 11 inches. The front face measures 20×12×0.125 inches. The back face measures 19×12×0.5 inches. The radius of the sound hole measures 2.5 inches. The top and bottom frames measures 12×2.25×0.5 inches. The top and bottom plates measure 12×8.75×0.5 inches. The tapered rabbet width measures 1 inch. The left and right frames measure 19×1×0.5 inches. The side panels measure 19×5×0.5 inches.

Although the invention has been explained in relation to its preferred embodiment, it is to be understood that many other possible modifications and variations can be made without departing from the spirit and scope of the invention as hereinafter claimed.

What is claimed is:

1. A collapsible cajón comprising:
a front face;
a back face;
a frame;
a top plate;
a bottom plate;
a plurality of side panels;
a plurality of hinges;
the front face being connected to the fame;
the plurality of hinges connecting the frame to the plurality of side panels;
the plurality of hinges connecting the plurality of side panels to the back face;
the plurality of hinges connecting the frame to the top plate; and
the plurality of hinges connecting the frame to the bottom plate.

2. The collapsible cajón of claim 1, the plurality of side panels further comprising:
a first left side panel;
a second left side panel;
a first right side panel; and
a second right side panel.

3. The collapsible cajón of claim 2, wherein:
the plurality of hinges connecting the first left side panel and the second left side panel; and
the plurality of hinges connecting the first right side panel and the second right side panel.

4. The collapsible cajón of claim 3, wherein
the plurality of hinges connecting the frame and the first left side panel;
the plurality of hinges connecting the frame and the first right side panel;
the plurality of hinges connecting the second left side panel and the back face; and
the plurality of hinges connecting the second right side panel and the back face.

5. The collapsible cajón of claim 1, wherein the frame further comprises:
a top frame;
a bottom frame;
a left frame;
a bottom frame;
the top frame being connected to a top surface of the left frame;
the top frame being connected to a top surface of the right frame;
the bottom frame being connected a bottom surface of the left frame; and
the bottom frame being connected to a bottom surface the right frame.

6. The collapsible cajón of claim 1, the plurality of hinges further comprising:
a plurality of cloth hinges; and
adhesive.

7. The collapsible cajón of claim 1, the back face further comprising:
a sound hole; and
the sound hole being disposed within the back face.

8. The collapsible cajón of claim 1, wherein:
the top plate further comprising a first tapered rabbet cut; and
the bottom plate further comprising a second tapered rabbet cut.

9. The collapsible cajón of claim 1, further comprising:
a first set of fasteners;
a second set of fasteners;
the first set of fasteners coupling the top plate and the back face; and
the second set of fasteners coupling the bottom plate and the back face.

10. A collapsible cajón comprising:
a front face;
a back face;
a set of frames;
a top plate;
a bottom plate;
a plurality of left side panels;
a plurality of right side panels;
a plurality of hinges;
the front face connected to the set of frames;
a first hinge of the plurality of hinges connecting the set of frames and the top plate;
a second hinge of the plurality of hinges connecting the set of frames and the bottom plate;
a third hinge of the plurality of hinges connecting the set of frames and the plurality of left side panels;
a fourth hinge of the plurality of hinges connecting the plurality of left side panels and the back face;
a fifth hinge of the plurality of hinges connecting the set of frames and plurality of right side panels; and
a sixth hinge of the plurality of hinges connecting the plurality of right side panels and the back face.

11. The collapsible cajón of claim 10, the set of frames further comprising:
a top frame;
a bottom frame;
a left frame;
a right frame;
the top frame being connected to a top surface of the left frame;
the top frame being connected to a top surface of the right frame;
the bottom frame being connected a bottom surface of the left frame; and
the bottom frame being connected to a bottom surface the right frame.

12. The collapsible cajón of claim 10, the plurality of left side panels further comprising:
a first left side panel;
a second left side panel;
a seventh hinge of the plurality of hinges connecting the first left side panel and
the second left side panel.

13. The collapsible cajón of claim 10, the plurality of right side panels further comprising:
a first right side panel;
a second right side panel; and
an eighth hinge of the plurality of hinges connecting the first right side panel and
the second right side panel.

14. The collapsible cajón of claim 10, the back face further comprising:
a sound hole;
the sound hole being disposed within the back face.

15. The collapsible cajón of claim 10, further comprising:
a first set of fasteners;
a second set of fasteners;
the first set of fasteners coupling the top plate and the back face; and
the second set of fasteners coupling the bottom plate and the back face.

16. A collapsible cajón comprising:
a front face;
a back face;
a top frame;
a bottom frame;
a top plate;
a bottom plate;
a left frame;
a right frame;
a first left side panel;
a second left side panel;
a first right side panel;
a second right side panel;
a plurality of hinges;
the back face further comprising a sound hole;
the front face connected to the top frame;
the front face connected to the bottom frame;
the front face connected to the left frame;
the front face connected to the right frame;
the top frame being connected to a top surface of the left frame;
the top frame being connected to a top surface of the right frame;
the bottom frame being connected a bottom surface of the left frame;
the bottom frame being connected to a bottom surface the right frame;
a first hinge of the plurality of hinges connecting the top plate and the top frame;
a second hinge of the plurality of hinges connecting the bottom plate and the bottom frame;
a third hinge of the plurality of hinges connecting the left frame and the first left side panel;
a fourth hinge of the plurality of hinges connecting the first left side panel and the second left side panel;
a fifth hinge of the plurality of hinges connecting the second left side panel and the back face;
a sixth hinge of the plurality of hinges connecting the right frame and the first right side panel;
a seventh hinge of the plurality of hinges connecting the first right side panel and the second right side panel; and
an eight hinge of the plurality of hinges connecting the second right side panel and the back face.

17. The collapsible cajón of claim 16, wherein the plurality of hinges further comprise:
a plurality of cloth hinges; and
adhesive.

18. The collapsible cajón of claim 16, wherein:
the top plate further comprising a first tapered rabbet cut; and
the bottom plate further comprising a second tapered rabbet cut.

19. The collapsible cajón of claim 16, the back face further comprising:
a sound hole;
the sound hole being disposed within the back face.

20. The collapsible cajón of claim 16, further comprising:
a first set of fasteners;
a second set of fasteners;
the first set of fasteners coupling the top plate and the back face; and
the second set of fasteners coupling the bottom plate and the back face.
